(19) United States
(12) Patent Application Publication
(10) Pub. No.: US 2010/0315408 A1
(43) Pub. Date: Dec. 16, 2010

(54) LIQUID CRYSTAL DISPLAY AND METHOD OF DRIVING THE SAME

(75) Inventors: Hyung-Ku KANG, Seoul (KR); Ho-young KIM, Cheonan-si (KR); Hak-Mo CHOI, Seoul (KR); Hyeonyong JANG, Osan-si (KR)

Correspondence Address: CANTOR COLBURN LLP, 20 Church Street, 22nd Floor, Hartford, CT, 06103, US

(73) Assignee: SAMSUNG ELECTRONICS CO., LTD., Suwon-si (KR)

(21) Appl. No.: 12/721,728

(22) Filed: Mar. 11, 2010

(30) Foreign Application Priority Data
Jun. 11, 2009 (KR) 10-2009-0051939

(51) Int. Cl. G09G 3/36; G06F 3/038

(52) U.S. Cl. 345/214; 345/87

(57) ABSTRACT

A liquid crystal display includes a liquid crystal display panel which displays an image in response to a gate signal and a data signal, a panel driving circuit which provides the gate signal and the data signal to the liquid crystal display panel in response to a control signal, a backlight unit including n light generating blocks which provide light to the liquid crystal display panel, and a backlight control unit which turns each of the n light generating blocks on and off i times during one frame period. Each of the n light generating blocks has a different duty ratio for each of i turn-on periods when the n light generating blocks are turned on in the one frame period, and ‘n’ and ‘i’ are integers greater than or equal to two (2).

This application claims priority to Korean Patent Application No. 10-2009-0051939,filed on Jun. 11, 2009, and all the benefits accruing therefrom under 35 U.S.C. § 119, the content of which in its entirety is herein incorporated by reference.

### BACKGROUND OF THE INVENTION

1. Field of the Invention

The present invention relates to a liquid crystal display and a method of driving the same. More particularly, the present invention relates to a liquid crystal display having substantially improved image display quality, and a method of driving the liquid crystal display.

2. Description of the Related Art

In general, a liquid crystal display (“LCD”) displays an image using a hold-type driving method. However, when the liquid crystal display displays a motion picture using the hold-type driving method, a motion picture blurring phenomenon occurs, due to a response speed of liquid crystal in pixels of the LCD.

To prevent the motion picture blurring phenomenon, an impulsive driving method that increases a driving frequency of a liquid crystal display panel in the LCD from 60 Hertz (Hz) to 120 Hz has been suggested. In the impulsive driving method, black (or gray) data is inserted between consecutive display frames as image data is applied to the liquid crystal display panel.

However, in the impulsive driving method, power consumption is substantially increased, due to the increase in the driving frequency. Additionally, the response speed of the liquid crystal is inadequate, due to a reduction of time duration of display frames during the impulsive driving of the liquid crystal display panel.

### BRIEF SUMMARY OF THE INVENTION

An exemplary embodiment of the present invention provides a liquid crystal display having advantages that include, but are not limited to, a substantially improved display quality.

An alternative exemplary embodiment of the present invention provides a method of driving the liquid crystal display.

According to an exemplary embodiment of the present invention, a liquid crystal display includes a liquid crystal display panel, a panel driving circuit, a backlight unit and a backlight control unit. The liquid crystal display panel displays an image in response to a gate signal and a data signal, and the panel driving circuit provides the gate signal and the data signal to the liquid crystal display panel in response to a control signal. The backlight unit includes ‘n’ light generating blocks which provide light to the liquid crystal display panel, and the backlight control unit turns each of the n light generating blocks on and off ‘i’ times during one frame period (‘n’ and ‘i’ are integers greater than or equal to 2). Each of the n light generating blocks has a different duty ratio for each of i turn-on periods when the n light generating blocks are turned on in the one frame period.

According to an alternative exemplary embodiment of the present invention, in a method of driving a liquid crystal display including a backlight unit having n light generating blocks, the method includes receiving light from the n light generating blocks to display an image in response to a gate signal and a data signal and turning on and off the n light generating blocks to control a duty ratio of each of the n light generating blocks. The light generating blocks are turned on and off i times during one frame period, and each of the n light generating blocks has a different duty ratio for each of the i times when the n light generating blocks are turned on in the one frame period.

According to the exemplary embodiments described herein, a backlight unit includes n light generating blocks, each of which is turned on and off corresponding to a liquid crystal response period of n reference pixel rows selected from pixel rows, and each of the n light generating blocks is turned on and off i times in a given frame period. Accordingly, a motion picture blurring phenomenon is substantially reduced and/or is effectively prevented from occurring in a liquid crystal display.

In addition, a duty ratio of turning the n light generating blocks on and off may be controlled based on a critical frequency corresponding to a brightness of the backlight unit. Thus, a flicker is effectively prevented from occurring, thereby further improving an image display quality of the liquid crystal display.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of an exemplary embodiment of a liquid crystal display (“LCD”) according to the present invention;

FIGS. 2 and 3 are plan views of first and second light generating blocks of the LCD shown in FIG. 1;

FIG. 4 is a signal timing diagram showing turn-on periods of the first and second light generating blocks shown in FIGS. 2 and 3;

FIG. 5 is a plan view showing a first reference gate line and a second reference gate line of the LCD shown in FIG. 1; and

FIG. 6 is a graph of frequency versus brightness showing critical frequencies according to brightness levels of a backlight unit of the LCD shown in FIG. 1.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiment of the present invention will be described in further detail with reference to the accompanying drawings.

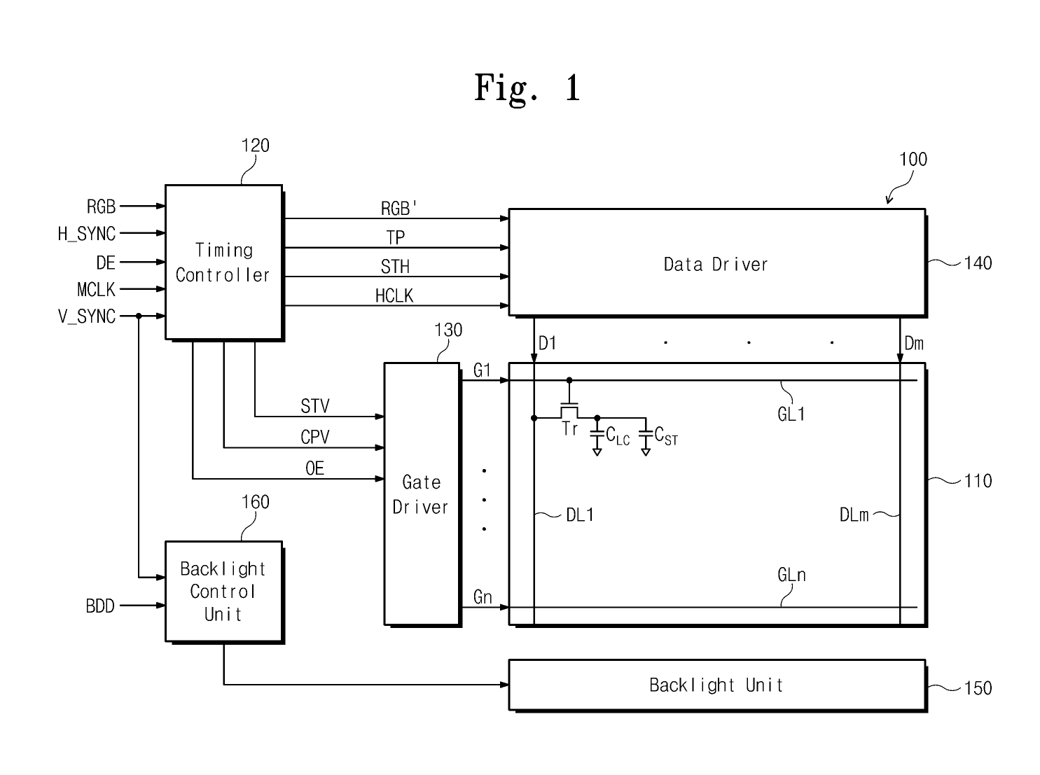

FIG. 1 is a block diagram of an exemplary embodiment of a liquid crystal display (“LCD”) according to the present invention.

Referring to FIG. 1, a liquid crystal display 100 includes a liquid crystal display panel 110, a timing controller 120, a gate driver 130, a data driver 140, a backlight unit 150 and a backlight control unit 160. In an exemplary embodiment, the timing controller 120, the gate driver 130 and the data driver 140 are collectively included in a panel driving circuit.

The liquid crystal display panel 110 includes gate lines GL1-GLn, data lines DL1-DLm crossing the gate lines GL1-GLn, and pixels disposed in pixel areas. Each of the pixels includes a thin film transistor Tr having a gate electrode connected to a corresponding gate line GL and a source electrode connected to a corresponding data line DL, a liquid crystal capacitor C_{LC} connected to a drain electrode of the thin film transistor Tr, and a storage capacitor C_{ST} connected to the drain electrode of the thin film transistor Tr.

The timing controller 120 receives an image data signal RGB, a horizontal synchronizing signal H_SYNC, a vertical synchronizing signal V_SYNC, a clock signal MCLK and a data enable signal DE. The timing controller 120 converts a data format of the image data signal RGB into a data format suitable for interface between the timing controller 120 and the data driver 140, and outputs a converted data signal RGB′ to the data driver 140. In addition, the timing controller 120 outputs data control signals (e.g., an output start signal TP, a horizontal start signal STH and a clock signal HCLK) to the data driver 140 and outputs gate control signals (e.g., a vertical start signal STV, a gate clock signal CPV and an output enable signal OE) to the gate driver 130.

The gate driver 130 sequentially applies gate signals G1-Gn to the gate lines GL1-GLn, respectively, of the liquid crystal display panel 110 in response to the gate control signals STV, CPV and OE from the timing controller 120 to sequentially scan the gate lines GL1-GLn.

The data driver 140 generates gray-scale voltages using gamma voltages provided from a gamma voltage generator (not shown). In response to the data control signals TP, STH and HCLK from the timing controller 120, the data driver 140 selects gray-scale voltages corresponding to the image data signal RGB′ from among the gray-scale voltages and applies the selected gray-scale voltages to the data lines DL1-DLm of the liquid crystal display panel 110 as the data signals D1-Dm.

Thus, the gate signals G1-Gm are sequentially applied to the gate lines GL1-GLn, respectively, while the data signals D1-Dm are applied to the data lines DL1-DLm, respectively. When a given gate signal G is applied to a selected gate line GL, the thin film transistor Tr connected to the selected gate line GL is turned on in response to the gate signal G applied to the selected gate line GL. The data signal D applied to a data line DL connected to the turned-on thin film transistor Tr is charged, e.g., the liquid crystal capacitor C_{LC} and the storage capacitor C_{ST} are charged through the turned-on thin film transistor Tr.

The liquid crystal capacitor C_{LC} controls a light transmittance of the liquid crystal according to a charged voltage thereof. The storage capacitor C_{ST} stores the data signal D while the thin film transistor Tr is turned on and applies, e.g., maintains, the stored data signal D to the liquid crystal capacitor C_{LC} while the thin film transistor Tr is turned off to maintain the charge of the liquid crystal capacitor C_{LC}. Thus, the liquid crystal display panel 110 displays a desired image.

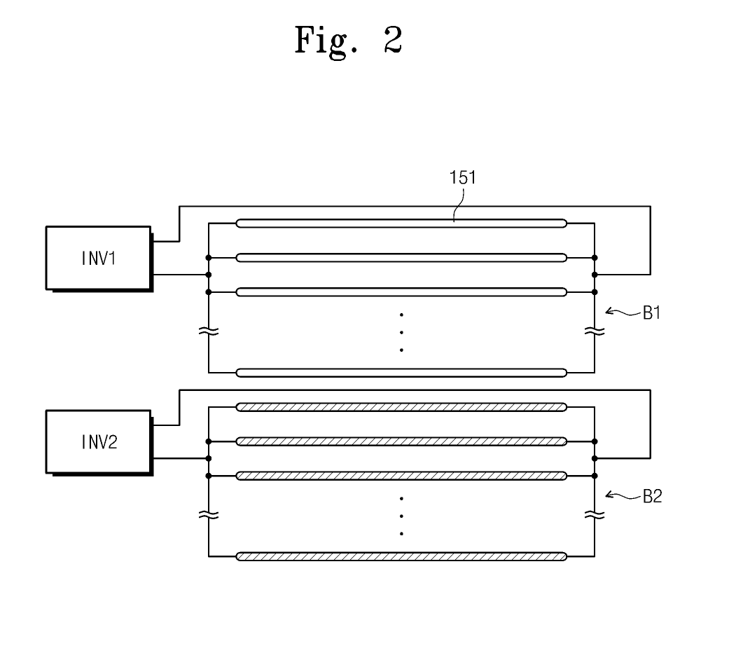

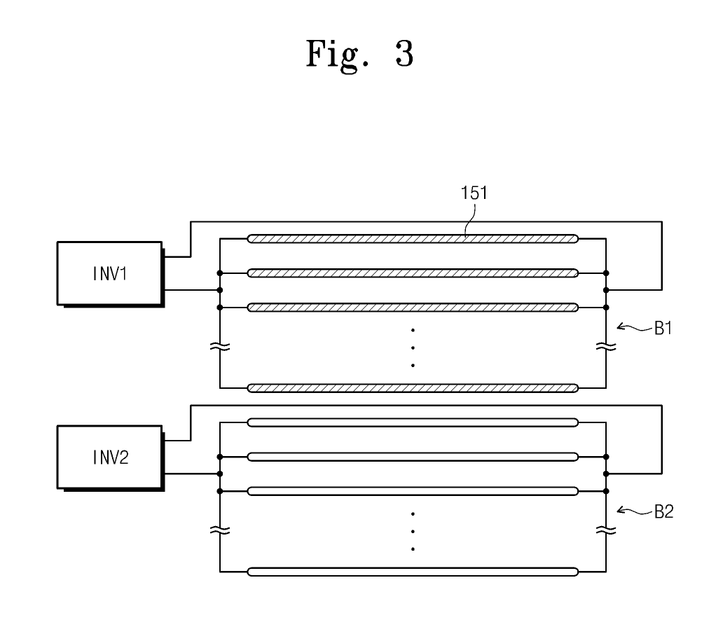

In an exemplary embodiment, the backlight unit 150 is disposed at rear, e.g., back, portion, such as a rear side, of the liquid crystal display panel 110 (relative to a front side thereof, from which the desired image is displayed) to provide light to the liquid crystal display panel 110. The backlight unit 150 includes light sources arranged in blocks, each of which includes at least one cold cathode fluorescent lamp 151. The cold cathode fluorescent lamps 151 extend along a direction substantially parallel to a longitudinal axis of the gate lines GL1-GLn and are alternately arranged along a direction substantially parallel with a longitudinal axis of the data lines DL1-DLm. The cold cathode fluorescent lamps 151 are grouped into n (where ‘n’ is an integer greater than or equal to 2) light generating blocks, as will now be described in further detail with reference to FIGS. 2 and 3.

FIGS. 2 and 3 are plan view of a first light generating block B1 and a second light generating block B2 of the LCD shown in FIG. 1. More specifically, FIG. 2 is a plan view showing a state when the first light generating block B1 is turned on and the second light generating block B2 is turned off, and FIG. 3 is a plan view showing a state when the first light generating block B1 is turned off and the second light generating block B2 is turned on.

In an exemplary embodiment of the present invention, the LCD includes two light generating blocks, e.g., the first light generating block B1 and the second light generating block B2, but it will be noted that alternative exemplary embodiments are not limited thereto, e.g., alternative exemplary embodiments include more than 2 light generating blocks.

As shown in FIGS. 2 and 3, the first light generating block B1 and the second light generating block B2 are connected to a first inverter INV1 and a second inverter INV2, respectively, and the first light generating block B1 and the second light generating block B2 may be independently operated. The first inverter INV1 and the second inverter INV2 may be included into the backlight control unit 160 (FIG. 1).

Referring to FIGS. 1-3, the backlight control unit 160 receives backlight driving information BDD from an external source (not shown) to turn on or turn off the first light generating block B1 and the second light generating block B2. In addition, the backlight control unit 160 controls a duty ratio of each of the first light generating block B1 and the second light generating block B2, based on the backlight driving information BDD. In an exemplary embodiment of the present invention, for example, the backlight driving information BDD may include brightness information of images displayed on the liquid crystal display panel 110 and duty ratio control signals determined from motion of the displayed images, but alternative exemplary embodiments are not limited thereto or thereby.

In addition, the backlight control unit 160 receives the vertical synchronizing signal V_SYNC that indicates the start of a frame among the control signals provided to the timing controller 120 from the external source, and determines a timing of a turn-on of each light generating block based on the vertical synchronizing signal V_SYNC. In an alternative exemplary embodiment of the present invention, the backlight control unit 160 may receive the vertical start signal STV that starts the operation of the gate driver 130 from the timing controller 120 and determine the timing of the turn-on of each light generating block based on the vertical synchronizing signal V_SYNC.

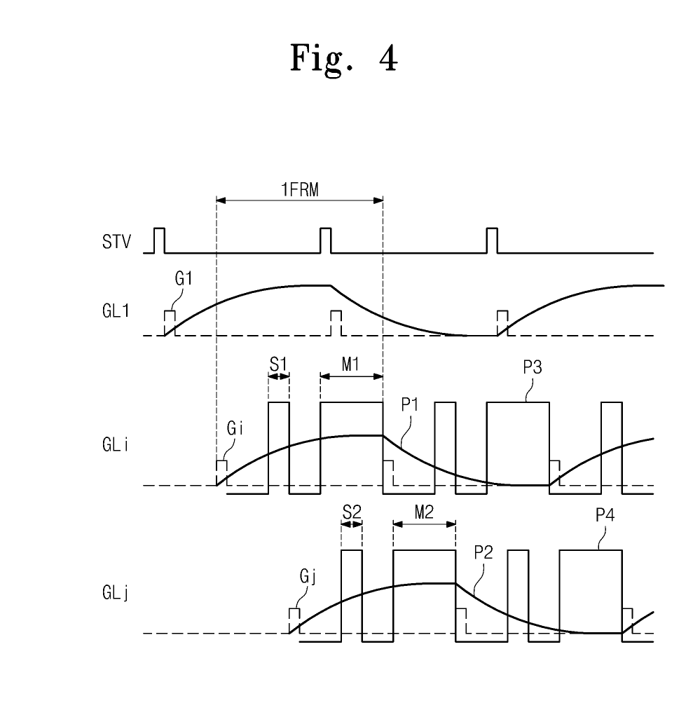

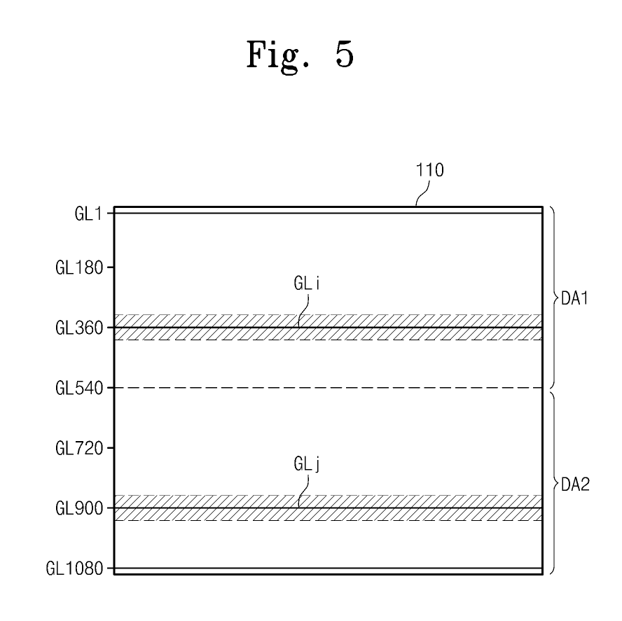

FIG. 4 is a signal timing diagram showing turn-on periods of the first light generating block B1 and the second light generating block B2, and FIG. 5 is a plan view showing a first reference gate line and a second reference gate line of the LCD shown in FIG. 1.

In an exemplary embodiment, the liquid crystal display panel 110 includes the gate lines GL1-GLn, as described above with reference to FIG. 1. However, for purposes of description herein, only a first gate line GL1, an i-th gate line GLi, and a j-th gate line GLj of the gate lines GL1-GLn have been shown in FIG. 4. In addition, as shown in FIG. 4, a first pulse P1 represents a response status of the liquid crystal of a first reference pixel row, a second pulse P2 represents a response status of the liquid crystal of a second reference pixel row, a third pulse P3 represents an operation status of the first light generating block B1, and a fourth pulse P4 represents an operation status of the second light generating block B2.

Referring to FIG. 4, a first gate signal GL1, an i-th gate signal Gi, and a j-th gate signal Gj are applied to the first gate line GL1, the i-th gate line GLi, and the j-th gate line GLj, respectively. One frame period 1FRM, which may also be referred to as an image display unit, of the liquid crystal display panel 110 is defined as a time duration from a time point at which a present gate signal is applied to a given gate line, e.g., the first gate line GL1, to a time point at which a next gate signal, e.g., a temporally subsequent and adjacent gate signal, is applied to the corresponding gate line (e.g., the first gate line GL1). In an exemplary embodiment, the liquid crystal display panel 110 is operated at 60 Hertz (Hz), and thus the one frame period may have a duration of 1/60 HZ, i.e., 16.7 milliseconds (ms).

The liquid crystal display panel 110 includes pixel rows corresponding to the gate lines GL1-GLn. Each of the pixel rows is turned on in response to a gate signal applied to a gate line corresponding thereto, and the liquid crystal corresponding to the turned-on pixel row responds to the turn-on of the pixel row. In the liquid crystal response period of each pixel row, a period during which the liquid crystal substantially fully responds to the turn-on of the pixel row, e.g., a period required for the liquid crystal capacitor to be adequately charged to display the desired image, corresponds to a portion of the one frame period 1FRM. Hereinafter, the period during which the liquid crystal substantially fully responds to the turn-on off the pixel row will be referred to as a “full response period.”

In an exemplary embodiment, n reference pixel rows (where ‘n’ is an integer equal to or larger than 2) of the pixel rows are selected. A number (n) of the n reference pixel rows depends on a number of the light generating blocks. More specifically, for example, when the backlight unit 150 includes two light generating blocks (e.g., the first light generating blocks B1 and the second light generating block B2, as discussed above), two reference pixel rows (hereinafter referred to as a “first reference pixel row” and a “second reference pixel row”) of the pixel rows may be selected. Additionally, gate lines connected to reference pixel rows are referred to as reference gate lines. Thus, in the exemplary embodiment shown in FIG. 4, the gate lines corresponding to the first and second pixel reference rows are referred to as first and second reference gate lines, respectively. More particularly, in an exemplary embodiment, i-th gate line GLi and the j-th gate line GLj may be the first reference gate line and the second reference gate line, respectively.

Each of the first light generating block B1 and the second light generating block B2 are turned on or off i times (where ‘i’ is an integer greater than or equal to 2) during one frame period 1FRM. In an exemplary embodiment, the backlight unit 150 is operated at 120 Hz, and thus, each of the first light generating block B1 and the second light generating block B2 may be turned on two times during the one frame period 1FRM, as shown in FIG. 4.

In an exemplary embodiment, the i turn-on periods include a main turn-on period during which the backlight unit 150 is turned on (corresponding to the full response period of the reference pixel row) and a sub turn-on period during which the backlight unit 150 is turned on (corresponding to a remaining response period of the reference pixel row). More particularly, the first light generating block B1 is turned on during a first main turn-on period M1, corresponding to the full response period of the first reference pixel row, and a first sub turn-on period S1, corresponding to a portion of the remaining response period of the first reference pixel row (in this case, i is equal to 2). Likewise, the second light generating block B2 is turned on during a second main turn-on period M2, corresponding to the full response period of the second reference pixel row, and a second sub turn-on period S2 corresponding to a portion of the remaining response period of the second reference pixel row.

To define a duration of the first main turn-on period M1, when the first reference pixel row is determined, the backlight control unit 160 calculates a first reference time duration from a time point at which the vertical start signal STV starts its rising to a time point at which the first reference pixel row is turned on. Accordingly, the backlight control unit 160 fixes a falling time point of the first main turn-on period M1 to a time point at which a first reference time duration lapses from a rising time point of the vertical start signal STV, and controls a width, e.g., a duration, of the first main turn-on period M1 according to a predetermined duty ratio. As a result, the duration of first main turn-on period M1 corresponds to the full response period of the first reference pixel row. Similarly, the second main turn-on period M2 is determined based on another predetermined duty ratio, such that the duration of second main turn-on period M2 corresponds to the full response period of the second reference pixel row.

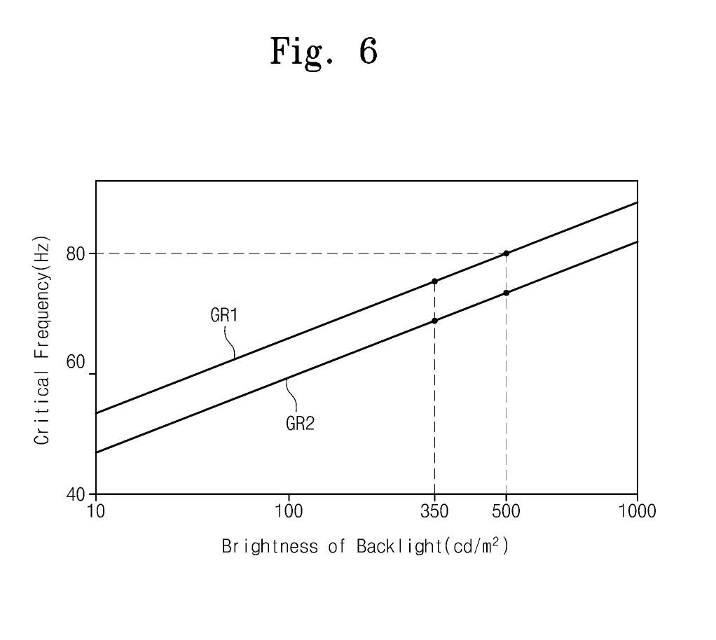

In an exemplary embodiment, the first main turn-on period M1 has a duty ratio that is greater than a duty ratio of the first sub turn-on period S1, while the second main turn-on period M2 has a duty ratio that is greater than a duty ratio of the second sub turn-on period S2, as shown in FIG. 4, and as will be described in greater detail below with reference to FIG. 6.

Referring now to FIG. 5, the liquid crystal display panel 110 according to an exemplary embodiment may be divided into a first display area DA1 and a second display area DA2 corresponding to the first light generating block B1 and the second light generating block B2, respectively. Thus, in an exemplary embodiment in which the liquid crystal display panel 110 includes 1080 gate lines GL1-GL1080, 540 gate lines GL1-GL540 are disposed in the first display area DA1, and 540 gate lines GL541-GL1080 are disposed in the second display area DA2, as shown in FIG. 6.

In an exemplary embodiment, the first reference gate line GLi may be a 360-th gate line GL360, and the second reference gate line GLj may be a 900-th gate line GL900, but alternative exemplary embodiments are not limited thereto. For example, in an alternative exemplary embodiment of the present invention, the first reference gate line GLi and the second reference gate line GLj may be a 540-th gate line GL540 and a 1080-th gate line GL1080, respectively, or the first reference gate line GLi and the second reference gate line GLj may be a first gate line GL1 and a 541-st gate line GL541, respectively. Thus, it will be understood that positions of the first reference gate line GLi and the second reference gate line GLj are not limited to the exemplary embodiments described and shown herein, but may instead be variously modified.

In an exemplary embodiment in which the first reference gate line GLi and the second reference gate line GLj are the 360-th gate line GL360 and the 900-th gate line GL900, respectively, the first main turn-on period M1 of the first light generating block B1 corresponds to the full response period of the reference pixel row connected to the 360-th gate line GL360, and the second main turn-on period M2 of the second light generating block B2 corresponds to the full response period of the reference pixel row connected to the 900-th gate line GL900.

Thus, in an exemplary embodiment, a motion picture response time (“MPRT”) is fully represented corresponding to the full response period (e.g., the main turn-on period), as opposed to in the remaining period (e.g., the sub turn-on period). Thus, when each light generating block is turned on in the full response period of the corresponding reference pixel row, a motion picture blurring phenomenon is effectively prevented from occurring when the motion picture is displayed on the LCD according to an exemplary embodiment, thereby substantially improving a display quality of the same.

In an exemplary embodiment described herein, the backlight unit 150 is divided into two light generating blocks, e.g., the first light generating block B1 and the second light generating block B2, but a number of the light generating blocks is not limited thereto, and may be may increased in alternative exemplary embodiments. As the number of the light generating blocks increases, the motion picture blurring phenomenon may be even more effectively reduced, thereby further improving a display quality of the LCD according to the exemplary embodiments described herein.

FIG. 6 is a graph of frequency, in Hertz (Hz), versus brightness, in candelas per square meter (cd/m²), showing a critical frequency according to a brightness of the backlight unit 150. As described herein, the critical frequency may be a frequency at which users do not perceive a flicker associated with the critical frequency. Thus, in FIG. 6, a first graph GR1 indicates a critical frequency at which about 90 percent of users do not perceive the flicker (for a corresponding brightness), and a second graph GR2 indicates a critical frequency that at which 50 percent of users do not perceive the flicker for a corresponding brightness.

Referring to FIG. 6, the critical frequency increases as the brightness of the backlight unit 150 increases (and vice versa). Thus, the critical frequency at which about 90 percent of users do not perceive flicker (graph GR1) is about 80 Hz when the brightness is about 500 cd/m², but when the brightness is reduced to 350 cd/m², the critical frequency is reduced to less than 80 Hz.

According to the characteristics represented in FIG. 6, critical frequency Y at which about 90 percent of users do not perceive flicker satisfies Equation 1, below.

Y=15logX+40 Equation 1

In Equation 1, “X” denotes the brightness of the backlight unit 150.

Thus, in an exemplary embodiment, the backlight control unit 160 calculates the critical frequency Y based on Equation 1.

Specifically, when the critical frequency Y is calculated at about 80 Hz and the backlight unit 150 is operated at a frequency less than 80 Hz, flicker may occur on a screen of the liquid crystal display panel 110. Accordingly, when the critical frequency is calculated at about 80 Hz, the backlight control unit 160 operates the backlight unit 150 at greater that 80 Hz (such as about 120 Hz, for example), thereby effectively preventing the occurrence of the flicker on the screen of the liquid crystal display panel 110.

To further reduce the motion picture blurring phenomenon when the backlight control unit 160 operates the backlight unit 150 at about 120 Hz, the main turn-on period of each light generating block has a duty ratio that is greater than a duty ratio of the sub turn-on period. Thus, since the main turn-on period corresponds to the liquid crystal response period of the reference pixel period, the motion picture blurring phenomenon is effectively reduced as the duration of the main turn-on period increases.

In an exemplary embodiment, the backlight control unit 160 may determine the duty ratio of the main turn-on period and the sub turn-on period of each light generating block based on the critical frequency Y. More particularly, the backlight control unit 160 may determine the duty ratio of the main turn-on period and the sub turn-on period of each light generating block based on Equation 2, below.

60×Du1+120×Du2≧Y(Du1+Du2) Equation 2

In Equation 2, “Du1” denotes the duty ratio of the main turn-on period, “Du2” denotes the duty ratio of the sub turn-on period, “Y” denotes the critical frequency, and “Du1+Du2” denotes a duty ratio of total turn-on period of each light generating block in the one frame period 1FRM.

More specifically, for example, when the critical frequency Y is calculated to be about 80 Hz and the duty ratio Du1+Du2 of the total turn-on period of each light generating block is set to about 50 percent, based on Equation 2, the duty ratio Du1 of the main turn-on period is calculated at about 33 percent and the duty ratio Du2 of the sub turn-on period is calculated at about 17 percent. In this case, the duty ratio Du1+Du2 of the total turn-on period may be set by a duty ratio control signal applied to the backlight control unit 160 for a dimming function.

Meanwhile, when the critical frequency Y increases above 80 Hz after the duty ratio Du1+Du2 of the total turn-on period is determined to be 50 percent, the duty ratio Du1 of the main turn-on period is reduced below 33 percent and the duty ratio Du2 of the sub turn-on period increases over 17 percent. In contrast, when the critical frequency Y is reduced below 80 Hz after the duty ratio Du1+Du2 of the total turn-on period is determined to be 50 percent, the duty ratio Du1 of the main turn-on period increases over 33 percent and the duty ratio Du2 of the sub turn-on period is reduced below 17 percent.

As described above, when the duty ratio of the main turn-on period and the sub turn-on period is determined based on the critical frequency Y, the motion picture blurring phenomenon is effectively reduced, without causing flicker in the LCD.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A liquid crystal display comprising:
a liquid crystal display panel which displays an image in response to a gate signal and a data signal;
a panel driving circuit which provides the gate signal and the data signal to the liquid crystal display panel in response to a control signal;
a backlight unit including n light generating blocks which provide light to the liquid crystal display panel; and
a backlight control unit which turns each of the n light generating blocks on and off i times during one frame period, wherein
n and i are integers greater than or equal to 2, and
each of the n light generating blocks has a different duty ratio for each of i turn-on periods when the n light generating blocks are turned on in the one frame period.

2. The liquid crystal display of claim 1, wherein the liquid crystal display panel comprises pixel rows, and one of the i times that each of the n light generating blocks is turned on in the one frame period corresponds to a liquid crystal response period of a corresponding reference pixel row of n reference pixel rows selected from the pixel rows.

3. The liquid crystal display of claim 2, wherein each of the i turn-on periods of each of the n light generating blocks comprises:
a main turn-on period corresponding to a full response period during which the liquid crystal of the corresponding reference pixel row of the n reference pixel rows fully responds; and
a sub turn-on period corresponding to a remaining portion of the period of the corresponding reference pixel row.

4. The liquid crystal display of claim 3, wherein the backlight control unit controls a duty ratio of the main turn-on period and a duty ratio of the sub turn-on period based on a critical frequency corresponding to a brightness of the backlight unit.

5. The liquid crystal display of claim 4, wherein the critical frequency increases as the brightness of the backlight unit increases.

6. The liquid crystal display of claim 5, wherein
the duty ratio of the main turn-on period is greater than the duty ratio of the sub turn-on period, and
as the critical frequency increases, the duty ratio of the main turn-on period decreases and the duty ratio of the sub turn-on period increases.

7. The liquid crystal display of claim 5, wherein the critical frequency is calculated by an equation Y=15logX+40, where Y denotes the critical frequency and X denotes the brightness of the backlight unit.

8. The liquid crystal display of claim 4, wherein
the liquid crystal display is operated at 60 Hertz, and
the backlight control unit turns on and off the backlight unit at 120 Hertz when n is equal to 2.

9. The liquid crystal display of claim 3, wherein the panel driving circuit comprises:
a timing controller which generates a gate control signal and a data control signal in response to the control signal;
a gate driver which outputs the gate signal in response to the gate control signal; and
a data driver which outputs the data signal in response to the data control signal.

10. The liquid crystal display of claim 9, wherein the backlight control unit determines the main turn-on period of each of the n light generating blocks in response to one of a vertical synchronizing signal and a vertical start signal.

11. The liquid crystal display of claim 1, wherein
each of the n light generating blocks comprises at least one cold cathode fluorescent lamp, and
the n light generating blocks are disposed at a rear portion of the liquid crystal display panel, opposite to a front portion thereof on which the image is displayed.

12. A method of driving a liquid crystal display including a backlight unit having n light generating blocks, the method comprising:
receiving light from the n light generating blocks to display an image in response to a gate signal and a data signal; and
turning on and off the n light generating blocks to control a duty ratio of each of the n light generating blocks, wherein
the light generating blocks are turned on and off i times during one frame period,
n and i are integers greater than or equal to 2, and
each of the n light generating blocks has a different duty ratio for each of the i times when the n light generating blocks are turned on in the one frame period.

13. The method of claim 12, wherein
the image is displayed by pixel rows which receive the gate signal and the data signal image, and
one of the i times that each of the n light generating blocks is turned on in the one frame period corresponds to a liquid crystal response period of a corresponding reference pixel row of n reference pixel rows selected from the pixel rows.

14. The method of claim 13, wherein each of the i turn-on periods of each of the n light generating blocks comprises:
a main turn-on period corresponding to a full response period during which a liquid crystal of the corresponding reference pixel row fully responds; and
a sub turn-on period corresponding to a remaining portion of the period of the corresponding reference pixel row.

15. The method of claim 14, wherein a backlight control unit controls a duty ratio of the main turn-on period and a duty ratio of the sub turn-on period based on a critical frequency corresponding to a brightness of the backlight unit.

16. The method of claim 15, wherein the critical frequency increases as the brightness of the backlight unit increases.

17. The method of claim 16, wherein
the duty ratio of the main turn-on period is greater than the duty ratio of the sub turn-on period, and
as the critical frequency increases, the duty ratio of the main turn-on period decreases and the duty ratio of the sub turn-on period increases.

18. The method of claim 16, wherein the critical frequency is calculated by an equation Y=15logX+40, wherein Y denotes the critical frequency and X denotes the brightness of the backlight unit.

19. The method of claim 12, wherein
the liquid crystal display is operated at 60 Hertz, and
the backlight control unit turns on and off the backlight unit at 120 Hertz when n is equal to 2.

20. The method of claim 12, wherein
each of the n light generating blocks comprises at least one cold cathode fluorescent lamp, and
the n light generating blocks are disposed at a rear portion of the liquid crystal display panel, opposite to a front portion thereof on which the image is displayed.
